(19) United States
(12) Patent Application Publication
(10) Pub. No.: US 2024/0387832 A1
(43) Pub. Date: Nov. 21, 2024

(54) ENERGY STORAGE ELEMENT

(71) Applicant: VARTA Microbattery GmbH, Ellwangen Jagst (DE)

(72) Inventors: Rainer STERN, Ellwangen (DE); Andreas SOLDNER, Dinkelsbuehl (DE); Martin ELMER, Ellwangen (DE)

(21) Appl. No.: 18/691,139

(22) PCT Filed: Aug. 22, 2022
(86) PCT No.: PCT/EP2022/073277

§ 371 Date: Mar. 12, 2024

(30) Foreign Application Priority Data
Sep. 17, 2021 (EP) 21197577.6

(51) Int. Cl. H01M 4/70; H01M 4/02; H01M 4/13; H01M 10/0525; H01M 10/0585; H01M 10/0587; H01M 50/103; H01M 50/107; H01M 50/119; H01M 50/463; H01M 50/534; H01M 50/536

(52) U.S. Cl. CPC H01M 4/70; H01M 4/13; H01M 10/0525; H01M 10/0585; H01M 10/0587; H01M 50/103; H01M 50/107; H01M 50/119; H01M 50/463; H01M 50/534; H01M 50/536; H01M 2004/021; H01M 2004/027; H01M 2004/028

(57) ABSTRACT

An energy storage element includes a first anode and a second anode, each including a negative electrode material and a common anode current collector. The common anode current collector comprises a first main region, a second main region, and a material-free connecting section that connects the first main region and the second main region. The energy storage element additionally includes a first cathode and a second cathode, each of the first cathode and the second cathode includes a positive electrode material and a common cathode current collector. The common cathode current collector comprises a first main region, a second main region, and a material-free connecting section that connects the first main region and the second main region. The energy storage element further includes a first contact sheet contacting a connecting section of the anode current collector and a second contact sheet contacting a connecting section of the cathode current collector.

### CROSS REFERENCE TO RELATED APPLICATIONS

This application is a U.S. National Phase application under 35 U.S.C. § 371 of International Application No. PCT/EP2022/073277, filed on Aug. 22, 2022, and claims benefit to European Patent Application No. EP 21197577.6, filed on Sep. 17, 2021. The International Application was published in German on Mar. 23, 2023 as WO/2023/041290 A1 under PCT Article 21(2).

### FIELD

The present disclosure relates to an energy storage element suitable for providing very high currents.

### BACKGROUND

Electrochemical energy storage elements can convert stored chemical energy into electrical energy through virtue of a redox-reaction. The simplest form of an electrochemical energy storage element is the electrochemical cell. It comprises a positive and a negative electrode, which are separated from each other by a separator. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs within the cell. This ion current crosses the separator and is made possible by an ion-conducting electrolyte.

If the discharge is reversible, i.e. it is possible to reverse the conversion of chemical energy into electrical energy during discharge and charge the cell again, this is said to be a secondary cell. The designation of the negative electrode as anode and the designation of the positive electrode as cathode, which is generally used for secondary cells, refers to the discharge function of the electrochemical cell.

Secondary lithium-ion cells are used as energy storage elements for many applications, as they can provide high currents and are characterized by a comparatively high energy density. They are based on the use of lithium, which can migrate back and forth between the electrodes of the cell in the form of ions. The negative electrode and the positive electrode of a lithium-ion cell are generally formed by so-called composite electrodes, which comprise electrochemically inactive components as well as electrochemically active components.

In principle, all materials that can absorb and release lithium ions can be used as electrochemically active components (active materials) for secondary lithium-ion cells. For example, carbon-based particles such as graphitic carbon are used for the negative electrode. Active materials for the positive electrode can be, for example, lithium cobalt oxide (LiCoO₂), lithium manganese oxide (LiMn₂O₄), lithium iron phosphate (LiFePO₄) or derivatives thereof. The electrochemically active materials are generally contained in the electrodes in particle form.

As electrochemically inactive components, the composite electrodes generally comprise a flat and/or strip-shaped current collector, for example a metallic foil, which serves as a carrier for the respective active material. The current collector for the negative electrode (anode current collector) can be made of copper or nickel, for example, and the current collector for the positive electrode (cathode current collector) can be made of aluminum, for example. Furthermore, the electrodes can comprise an electrode binder (e.g. polyvinylidene fluoride (PVDF) or another polymer, for example carboxymethyl cellulose), conductivity-improving additives and other additives as electrochemically inactive components. The electrode binder ensures the mechanical stability of the electrodes and often also the adhesion of the active material to the current collectors.

As electrolytes, lithium-ion cells generally comprise solutions of lithium salts such as lithium hexafluorophosphate (LiPF₆) in organic solvents (e.g. ethers and esters of carbonic acid).

During manufacturing of a lithium-ion cell the composite electrodes are combined with one or more separators to form an assembly. In this process, the electrodes and separators are often connected under pressure, possibly also by lamination or bonding. The basic functionality of the cell can then be established by impregnating the assembly with the electrolyte.

In many embodiments, the assembly is formed in the form of a winding or processed into a winding. Alternatively, the assembly can also be a stack of electrodes.

For applications in the automotive sector, for e-bikes or for other applications with high energy requirements, such as in tools, lithium-ion cells with the highest possible energy density are required that are also capable of withstanding high currents during charging and discharging.

WO 2017/215900 A1 describes cylindrical round cells in which an assembly is formed from ribbon-shaped electrodes and is in the form of a winding. The electrodes each have current collectors loaded with electrode material. Oppositely polarized electrodes are arranged offset to each other within the assembly so that longitudinal edges of the current collectors of the positive electrodes protrude from one side and longitudinal edges of the current collectors of the negative electrodes protrude from another side of the winding. For electrical contacting of the current collectors, the cell has contact plates that sit on the end faces of the winding and are connected to the longitudinal edges of the current collectors by welding. This makes it possible to electrically contact the current collectors and thus also the associated electrodes over their entire length. This significantly reduces the internal resistance within the described cell. As a result, the occurrence of large currents can be absorbed much better and heat can also be dissipated better from the winding.

A potential problem here is that the edges of the current collectors are often compressed in an uncontrolled manner when the contact plates are applied, which can result in undefined folds. This makes large-area, positive contact between the end faces and the contact plates more difficult. In addition, the risk of fine or short circuits on the end face is elevated, for example as a result of damage to the separator located between the electrodes.

To solve this problem, WO 2020/096973 A1 proposes pretreating the edges of the current collectors, in particular removing parts of the current collector edges so that they are rectangular in shape.

Targeted pre-deformation of the edges of current collectors is known from US 2018/0190962 A1 and JP 2015-149499 A.

The known solutions have the disadvantage that the pre-treatment of the current collector edges is very complex.

### SUMMARY

In an embodiment, the present disclosure provides an energy storage element. The energy storage element includes a first anode and a second anode. Each of the first anode and the second anode includes a negative electrode material and a common anode current collector. The common anode current collector comprises a first main region, a second main region, and a material-free connecting section that connects the first main region and the second main region. The first main region of the common anode current collector is loaded on both sides with a layer of the negative electrode material to form the first anode. The second main region of the common anode current collector is loaded on both sides with a layer of the negative electrode material to form the second anode. The material-free connecting section of the common anode current collector is not loaded with the electrode material. The energy storage element additionally includes a first cathode and a second cathode. Each of the first cathode and the second cathode includes a positive electrode material and a common cathode current collector. The common cathode current collector comprises a first main region, a second main region, and a material-free connecting section that connects the first main region and the second main region. The first main region of the common cathode current collector is loaded on both sides with a layer of the positive electrode material to form the first cathode. The second main region of the common cathode current collector is loaded on both sides with a layer of the positive electrode material to form the second cathode. The material-free connecting section of the common cathode current collector is not loaded with the electrode material. The energy storage element further includes a first contact sheet and a second contact sheet. The first anode, the second anode, the first cathode, and the second cathode form an assembly in which the anodes and cathodes are separated by separator layers in a sequence first anode/separator layer/first cathode/separator layer/second anode/separator layer/second cathode. Within the assembly, the material-free connecting section of the common anode current collector is bent and connects the first anode and the second anode and the material-free connecting section of the common cathode current collector is bent and connects the first cathode and the second cathode. The bent connecting portion of the anode current collector protrudes from one side of the assembly and the bent connecting portion of the cathode current collector protrudes from another side of the assembly. The first contact sheet is in direct contact with the bent connecting section of the common anode current collector and the second contact sheet is in contact with the bent connecting section of the common cathode current collector.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a illustrates a cross-section through a cell of the prior art, in which a contact plate has been pressed onto a projecting edge of a current collector;

FIG. 2 provides a schematic view of a first anode and a second anode with a common current collector (top view and cross-section);

FIG. 3 provides a schematic view of a first cathode and a second cathode with a common current collector (top view and cross-section);

FIG. 4 provides a schematic view of an assembly formed from the anodes shown in FIG. 2 and the cathodes shown in FIG. 3 (cross-sectional view);

FIG. 5 provides a schematic view of a prismatic assembly with two contact plates resting on it (cross-sectional view);

FIG. 6 provides a top view of the electrodes of the assembly shown in FIG. 5;

FIG. 7 provides a schematic view of an energy storage element comprising the prismatic composite body shown in FIG. 5 and a housing therefor (cross-sectional view);

FIG. 8 illustrates a current collector with two strips of an electrode material which are connected by a structurally weakened central strip (top view from above);

FIG. 9 illustrates a further embodiment of an assembly which can be formed from anodes and cathodes according to FIGS. 2 and 3; and

FIG. 10 illustrates an embodiment of a prismatic assembly with two contact plates resting on it (cross-sectional view).

### DETAILED DESCRIPTION

The present disclosure provides energy storage elements characterized by an assembly of electrodes and one or more separators that can be contacted more easily via contact plates. Energy storage elements according to the present disclosure provide for improved safety.

Energy storage element An energy storage element according to a first aspect of the disclosure includes the following features a. to h:
a. It comprises a cathode and an anode which are part of an assembly in which they are separated by a separator or a solid electrolyte layer and are present in the sequence cathode/separator or solid electrolyte layer/anode,
b. the cathode comprises a cathode current collector and a positive electrode material,
c. the cathode current collector has a main area loaded with a layer of the positive electrode material, and a free edge strip which extends along one edge of the cathode current collectors and which is not loaded with the positive electrode material,
d. the anode comprises an anode current collector and a negative electrode material,
e. the anode current collector has a main area loaded with a layer of the negative electrode material, and a free edge strip which extends along one edge of the anode current collectors and which is not loaded with the negative electrode material,
f. the anode and the cathode are designed and/or arranged relative to each other within the electrode-separator assembly in such a way that the free edge strip of the anode current collector protrudes from one side of the assembly and the free edge strip of the cathode current collector protrudes from another side of the assembly,
g. the cell comprises a first contact sheet metal member which is in direct contact with one of the free edge strips and a second contact sheet metal member which is in direct contact with the other of the free edge strips, and
h. at least one of the edge strips being in direct contact with one of the contact sheet metal members has a U-shaped or V-shaped cross-section as a result of a bending process and thus an elongated depression or indentation on one side and on the other side an elongated elevation corresponding to the depression.

The energy storage element according to the first aspect of the disclosure is thus characterized by the fact that it has current collectors whose free edge strips have been subjected to a bending process. Within the assembly, two positive and two negative electrodes are connected to each other via a common current collector, wherein two connected electrodes of the same polarity sandwich an electrode of the opposite polarity.

### Cylindrical Design

According to an embodiment, the energy storage element according to the first aspect of the disclosure can be designed as a cylindrical round cell. In the cylindrical embodiment, it has the immediately following features a. to g:
a. The electrodes and the current collectors as well as the layers of electrode materials are ribbon-shaped.
b. The connecting sections are strip-shaped.
c. It comprises at least one ribbon-shaped separator which comprises the separator layers.
d. The assembly is in the form of a cylindrical winding with two terminal end faces and a winding shell in which the electrodes and the at least one separator are spirally wound.
e. It comprises a cylindrical metal housing with a circumferential housing shell and, at the end faces, a circular bottom and a lid.
f. In the metal housing, the assembly designed as a winding is axially aligned so that the winding shell abuts the inside of the circumferential housing shell.
g. The bent connecting sections of the current collectors protrude from the terminal end faces of the winding.

In this embodiment, the assembly preferably comprises a ribbon-shaped separator or two ribbon-shaped separators, each of which has a first and a second longitudinal edge and two ends.

In this embodiment, the energy storage element is preferably characterized by the feature a. immediately below:
a. The metal housing comprises a cup-shaped, cylindrical housing part with a terminal opening and a lid component which closes the terminal opening of the cup-shaped housing part.

Preferably, the lid component has a circular circumference and is arranged in the circular opening of the cup-shaped housing part in such a way that the edge abuts the inside of the cup-shaped housing part along a circumferential contact zone, wherein the edge of the lid component is connected to the cup-shaped housing part via a circumferential weld seam. In this case, the two housing parts preferably have the same polarity, i.e. they are electrically coupled to either a positive or a negative electrode. In this case, the housing also comprises a pole bushing, which is used to make electrical contact with the electrode that is not electrically connected to the housing.

In an alternative embodiment, an electrically insulating seal is fitted to the edge of the lid component, which electrically separates the lid component from the cup-shaped housing part. In this case, the housing is usually sealed by a crimp closure.

The height of energy storage elements designed as cylindrical round cells is preferably in the range from 50 mm to 150 mm. The diameter of the cylindrical round cells is preferably in the range from 15 mm to 60 mm. Cylindrical round cells with these form factors are suitable for supplying power to electric drives in motor vehicles.

In embodiments in which the cell is a cylindrical round cell, the anode current collector, the cathode current collector and the separator or separators preferably have the following dimensions:
A length in the range from 0.5 m to 25 m
A width in the range from 30 mm to 145 mm

In this embodiment, the contact sheet metal members preferably have a circular basic shape.

### Prismatic Design

According to an embodiment, the energy storage element according to the first aspect of the disclosure can be designed as a prismatic cell. In the prismatic embodiment, the energy storage element has the immediately following features a. to f.:
a. The electrodes and the current collectors as well as the layers of electrode materials are polygonal, preferably rectangular.
b. The connecting sections are strip-shaped.
c. It comprises at least one ribbon-shaped or rectangular separator which comprises the separator layers.
d. The assembly is in the form of a prismatic stack in which the electrodes and the separator layers are stacked.
e. The stack is enclosed in a prismatic housing,
f. The bent connecting sections of the current collectors protrude from the adjacent or opposite sides of the stack.

The prismatic housing is preferably composed of a cup-shaped housing part with a terminal opening and a lid component. In this embodiment, the bottom of the cup-shaped housing part and the lid component preferably have a polygonal, e.g. rectangular base. The shape of the terminal opening of the cup-shaped housing part corresponds to the shape of the bottom and the lid component. In addition, the housing comprises several, preferably four, rectangular side parts which connect the bottom and the lid component to one another.

The separator layers can be formed by several separators, each of which is arranged between adjacent electrodes. However, it is also possible for a ribbon-shaped separator to separate the electrodes of the stack from each other. In the case of several separators between the anodes and cathodes, the separators preferably also have a polygonal, in particular rectangular, base area.

In this embodiment, the contact sheet metal members preferably have a rectangular basic shape.

### Preferred Electrochemical Embodiment

According to embodiments, the energy storage element according to the first aspect of the disclosure can be characterized by one of the following features:
a. The energy storage element is a lithium-ion cell.
b. The energy storage element comprises a lithium-ion cell.
Feature a. refers, for example, to a described embodiment of the energy storage element as a cylindrical round cell. In this embodiment, the energy storage element preferably comprises exactly one electrochemical cell.
Feature b. refers, for example, to a described prismatic embodiment. In this embodiment, the energy storage element may also comprise more than one electrochemical cell.

Basically, all electrode materials known for secondary lithium-ion cells can be used for the electrodes of the energy storage element.

Carbon-based particles such as graphitic carbon or non-graphitic carbon materials capable of intercalating lithium, preferably also in particle form, can be used as active materials in the negative electrodes. Alternatively or additionally, lithium titanate (Li₄Ti₅O₁₂) or a derivative thereof can also be contained in the negative electrode, preferably also in particle form. Furthermore, the negative electrode can contain as active material at least one material from the group comprising silicon, aluminum, tin, antimony or a compound or alloy of these materials that can reversibly store and release lithium, for example silicon oxide, optionally in combination with carbon-based active materials. Tin, aluminum, antimony and silicon can form intermetallic phases with lithium. The capacity to absorb lithium exceeds that of graphite or comparable materials many times over, especially in the case of silicon. Thin anodes made of metallic lithium are also possible.

Suitable active materials for the positive electrodes include lithium metal oxide compounds and lithium metal phosphate compounds such as LiCoO₂ and LiFePO₄. Lithium nickel manganese cobalt oxide (NMC) with the chemical formula LiNiₓMn_{y}Co_{z}O₂ (wherein x+y+z is typically 1) is also suitable, lithium manganese spinel (LMO) with the chemical formula LiMn₂O₄, or lithium nickel cobalt aluminum oxide (NCA) with the chemical formula LiNiₓCo_{y}Al_{z}O₂ (wherein x+y+z is typically 1). Derivatives thereof, for example lithium nickel manganese cobalt aluminum oxide (NMCA) with the chemical formula Li_{1.11}(Ni_{0.40}Mn_{0.39}Co_{0.16}Al_{0.05})_{0.89}O₂ or Li₁₊ₓM—O compounds and/or mixtures of the aforementioned materials can also be used. The cathodic active materials are also preferably used in particulate form.

In addition, the electrodes of an energy storage element preferably contain an electrode binder and/or an additive to improve the electrical conductivity. The active materials are preferably embedded in a matrix of the electrode binder, wherein neighboring particles in the matrix are preferably in direct contact with each other. Conductive agents have the function of elevating the electrical conductivity of the electrodes. Common electrode binders are based, for example, on polyvinylidene fluoride (PVDF), polyacrylate or carboxymethyl cellulose. Common conductive agents are carbon black and metal powder.

The energy storage element preferably comprises an electrolyte, in the case of a lithium-ion cell in particular an electrolyte based on at least one lithium salt such as lithium hexafluorophosphate (LiPF₆), which is present dissolved in an organic solvent (e.g. in a mixture of organic carbonates or a cyclic ether such as THF or a nitrile). Other lithium salts that can be used are, for example, lithium tetrafluoroborate (LiBF₄), lithium bis(trifluoromethanesulfonyl)imide (LiTFSI), lithium bis(fluorosulfonyl)imide (LiFSI) and lithium bis(oxalato)borate (LiBOB).

The nominal capacity of a lithium-ion-based energy storage element designed as a cylindrical round cell is preferably up to 90000 mAh. With the form factor of 21×70, the energy storage element in one embodiment as a lithium-ion cell preferably has a nominal capacity in the range from 1500 mAh to 7000 mAh, preferably in the range from 3000 to 5500 mAh. With the form factor of 18×65, the cell in one embodiment as a lithium-ion cell preferably has a nominal capacity in the range from 1000 mAh to 5000 mAh, preferably in the range from 2000 to 4000 mAh.

In the European Union, manufacturers' information on the nominal capacity of secondary batteries is strictly regulated. For example, information on the nominal capacity of secondary nickel-cadmium batteries must be based on measurements according to the IEC/EN 61951-1 and IEC/EN 60622 standards, information on the nominal capacity of secondary nickel-metal hydride batteries must be based on measurements according to the IEC/EN 61951-2 standard, information on the nominal capacity of secondary lithium batteries must be based on measurements according to the IEC/EN 61960 standard and information on the nominal capacity of secondary lead-acid batteries must be based on measurements according to the IEC/EN 61056-1 standard. Any information on nominal capacities in the present application is preferably also based on these standards.

### Preferred Embodiments of the Separator

Preferably, the separator or separators are formed from electrically insulating plastic films. It is preferable that the separators can be penetrated by the electrolyte. For this purpose, the plastic films used can have micropores, for example. The foil can consist of a polyolefin or a polyether ketone, for example. Nonwovens and fabrics made of plastic materials or other electrically insulating fabrics can also be used as separators. Separators with a thickness in the range from 5 μm to 50 μm are preferred.

In particular in the prismatic embodiments of the energy storage element, the separator or separators of the assembly can also be one or more layers of a solid electrolyte.

### Preferred Structure of an Assembly Formed as a Winding

The ribbon-shaped anode, the ribbon-shaped cathode and the ribbon-shaped separator(s) are preferably spirally wound in the assembly formed as a winding. To produce the assembly, the ribbon-shaped electrodes together with the ribbon-shaped separator(s) are fed to a winding device and preferably wound up spirally around a winding axis in the winding device. In some embodiments, the electrodes and the separator are wound onto a cylindrical or hollow-cylindrical winding core for this purpose, which is seated on a winding mandrel and remains in the winding after winding.

The winding shell can be formed by a plastic film or an adhesive tape, for example. It is also possible for the winding shell to be formed by one or more separator windings.

### Preferred Embodiments of the Current Collectors

The current collectors of the energy storage element have the function of electrically contacting the electrochemically active components contained in the respective electrode material over as large an area as possible. Preferably, the current collectors consist of a metal or are at least metallized on the surface. In the case of an energy storage element based on lithium-ion technology, suitable metals for the anode current collector include copper or nickel or other electrically conductive materials, in particular copper and nickel alloys or nickel-coated metals. Stainless steel is also an option. In the case of an energy storage element based on lithium-ion technology, aluminum or other electrically conductive materials, including aluminum alloys, are suitable as a metal for the cathode current collector.

Preferably, the anode current collector and/or the cathode current collector are each a metal foil with a thickness in the region of 4 μm to 30 μm, in the case of the described configuration of the energy storage element as a cylindrical round cell, a ribbon-shaped metal foil with a thickness in the range from 4 μm to 30 μm.

In addition to foils, however, other strip-shaped substrates such as metallic or metallized nonwovens or open-pored metallic foams or expanded metals can also be used as current collectors.

In the case of the described configuration of the energy storage element as a cylindrical round cell, it is preferred that the longitudinal edges of the separator(s) form the end faces of the assembly, which is designed as a winding.

In the case of the described prismatic configuration of the energy storage element, it is preferred that the edges of the separator(s) form the sides of the stack from which the bent connecting portions of the current collectors protrude.

It is further preferred that the bent connecting sections of the current collectors protruding from the terminal end faces of the winding or sides of the stack do not exceed 5500 μm, preferably not more than 4000 μm, from the end faces or sides.

Preferably, the bent connecting section of the anode current collector protrudes from the side of the stack or the end face of the winding by no more than 3000 μm, preferably by no more than 2000 μm. Preferably, the bent connecting section of the cathode current collector protrudes from the side of the stack or the end face of the winding by no more than 4000 μm, preferably by no more than 3000 μm.

### Preferred Embodiments of the First Contact Sheet Metal Member/Connection of the First Contact Sheet Metal Member to the Anode Current Collector

The first contact sheet metal member is preferably electrically connected to the anode current collector. It is preferably connected directly to the bent connecting section of the anode current collector by welding.

In an alternative embodiment, however, the first contact sheet metal member can also be mechanically connected to the bent connecting section of the anode current collector, for example by a press connection or a clamp connection or a spring connection.

In a preferred embodiment, the first contact sheet metal member is characterized by at least one of the features a. or b. immediately below:
a. The contact sheet metal member consists of nickel or copper or titanium or a nickel or copper or titanium alloy or stainless steel.
b. The contact sheet metal member consists of the same material as the anode current collector.

It is preferred that the immediately preceding features a. and b. are realized in combination with each other.

The contact sheet metal member is either electrically connected to the housing or to a contact pole that passes through the housing and is electrically insulated from the housing. The electrical contact can be realized by welding or a mechanical connection. If necessary, the electrical connection can also be made via a separate electrical conductor.

In a further preferred embodiment, the first contact sheet metal member is characterized by at least one of the features a. to g. immediately below:
a. The contact sheet metal member has a preferably uniform thickness in the range from 50 μm to 600 μm, preferably in the range from 150 μm to 350 μm.
b. The contact sheet metal member has two opposite flat sides and extends essentially in only one dimension.
c. The contact sheet metal member is a disk or preferably a rectangular plate.
d. The contact sheet metal member is dimensioned such that it covers at least 600%, preferably at least 70%, preferably at least 80%, of the side or end face from which the bent connecting section of the anode current collector emerges.
e. The contact sheet metal member has at least one aperture, in particular at least one hole and or at least one slot.
f. The contact sheet has at least one bead, which appears on one flat side of the contact sheet as an elongated depression and on the opposite flat side as an elongated elevation, wherein the contact sheet sits with the flat side, which carries the elongated elevation, on the bent connecting section of the anode current collector.
g. The contact sheet metal member is welded to the bent connecting section of the anode current collector in the region of the bead, in particular via one or more weld seams positioned in the bead.

It is preferred that the immediately preceding features a. and b. and d. are realized in combination with each other. In a preferred embodiment, features a. and b. and d. are realized in combination with one of features c. or e. or features f. and g. Preferably, all features a. to g. are realized in combination with each other.

Covering as much of the end face as possible is important for the thermal management of the grounded energy storage element. The larger the cover, the easier it is to contact the first edge of the anode current collector over its entire length. Heat formed in the assembly can thus be dissipated well via the contact sheet metal member.

The at least one aperture in the contact sheet metal member can be expedient, for example, in order to be able to impregnate the assembly with an electrolyte.

In a preferred embodiment, the assembly has a side from which more than one bent connecting section of an anode current collector protrudes. In a further development of this embodiment, it is preferred that at least two of the bent connecting sections, preferably several adjacent connecting sections, are in direct contact with each other, i.e. are not only electrically connected to each other via the first contact sheet metal member.

### Preferred Embodiments of the Second Contact Sheet Metal Member/Connection of the Second Contact Sheet Metal Member to the Cathode Current Collector

The second contact sheet metal member is preferably electrically connected to the cathode current collector. It is preferably connected directly to the bent connecting section of the cathode current collector by welding.

In an alternative embodiment, however, the second contact sheet metal member can also be mechanically connected to the bent connecting section of the cathode current collector, for example by means of a press connection, a spring connection or a clamp connection.

In a preferred embodiment, the energy storage element is characterized by the feature a. immediately below:
a. The second contact sheet metal member consists of aluminum or an aluminum alloy.

The contact sheet metal member is either electrically connected to the housing or to a contact pole that passes through the housing and is electrically insulated from the housing. The electrical contact can be realized by welding or a mechanical connection. If necessary, the electrical connection can also be made via a separate electrical conductor.

The second contact sheet metal member is preferably, apart from its material composition, similar to the contact sheet metal member resting on the first edge of the anode current collector. It is preferably characterized by at least one of the features a. to g. immediately below:
a. The second contact sheet metal member has a preferably uniform thickness in the range from 50 μm to 600 μm, preferably in the range from 150 μm to 350 μm.
b. The second contact sheet metal member has two opposite flat sides and extends essentially in only one dimension.
c. The second contact sheet metal member is a disk or preferably a rectangular plate.
d. The second contact sheet metal member is dimensioned such that it covers at least 60%, preferably at least 70%, preferably at least 80%, of the side or end face from which the bent connecting section of the cathode current collector emerges.
e. The second contact sheet metal member has at least one aperture, in particular at least one hole and or at least one slot.
f. The second contact sheet has at least one bead, which appears on one flat side of the contact sheet as an elongated depression and on the opposite flat side as an elongated elevation, wherein the contact sheet sits with the flat side, which carries the elongated elevation, on the bent connecting section of the cathode current collector.
g. The second contact sheet metal member is welded to the bent connecting section of the cathode current collector in the region of the bead, in particular via one or more weld seams positioned in the bead.

Here, too, it is preferred that the immediately preceding features a. and b. and d. are realized in combination with one another. In a preferred embodiment, features a. and b. and d. are realized in combination with one of features c. or e. or features f. and g. In a preferred embodiment, all features a. to g. are also realized in combination with each other.

The connection or welding of the bent connecting section of the cathode current collector to the second contact sheet metal member is preferably realized in the same way as the connection of the bent connecting section of the anode current collector described above, i.e. preferably via a weld in the region of the bead.

In preferred embodiments, the second contact sheet metal member is welded directly to the bottom of the cup-shaped housing part or a part of the bottom. In further preferred embodiments, the second contact sheet metal member is connected to the bottom of the cup-shaped housing part via a separate current conductor. In the latter case, it is preferred that the separate current conductor is welded both to the bottom of the cup-shaped housing part and to the second contact sheet metal member. The separate current conductor preferably consists of aluminum or an aluminum alloy.

In a preferred embodiment, the assembly has a side from which more than one bent connecting section of a cathode current collector protrudes. In a further development of this embodiment, it is preferred that at least two of the bent connecting sections, preferably several adjacent connecting sections, are in direct contact with each other, i.e. are not only electrically connected to each other via the second contact sheet metal member.

### Preferred Embodiment of the Housing Parts

In a further preferred embodiment, the energy storage element is characterized by at least one of the features a. and b. immediately below:
a. The cup-shaped housing part consists of aluminum, stainless steel or nickel-plated steel.
b. The lid component consists of aluminum, stainless steel or nickel-plated steel.

The immediately preceding features a. and b. are preferably realized in combination.

In some embodiments, a direct connection of the bent connecting section of the cathode current collector to the housing is desirable. For this purpose, the bent connecting section can be welded to the bottom of the cup-shaped housing part using a laser, for example. In this case, the bottom of the cup-shaped housing part serves as a second contact plate.

Conversely, in some embodiments, it may be provided that the first contact plate serves as a lid component, i.e. serves as part of the housing.

### Preferred Embodiment of the Electrodes

In a further preferred embodiment, the energy storage element is characterized by one of the features a. or b. immediately below:
a. The energy storage element is designed as a cylindrical round cell and its electrodes have a thickness in the range from 40 μm to 300 μm, preferably in the region from 40 μm to 100 μm.
b. The energy storage element is prismatic and its electrodes have a thickness in the range from 40 μm to 1000 μm, preferably a thickness >100 μm to a maximum of 300 μm.

In the case of a cylindrical configuration, the first and second anode as well as the first and second cathode are wound simultaneously, but the electrode on the outside would have to be slightly longer than the electrode on the inside for the same number of turns. To avoid problems, the thickness of the electrodes in a cylindrical configuration is preferably very small. This aspect does not play a role in a prismatic configuration.

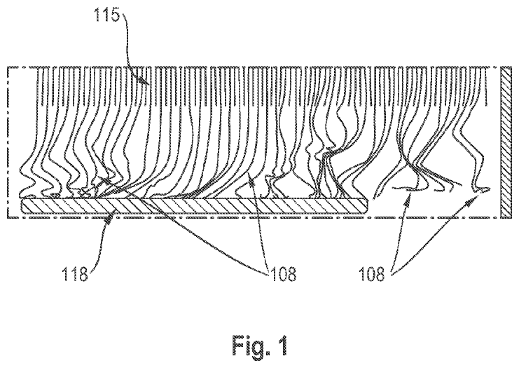

FIG. 1 illustrates the result of pressing a contact plate 118 onto a protruding edge 108 of a current collector protruding from one side of an assembly 115 of negative and positive electrodes and separators. During the press-on, uncontrolled compression of the edges 108 of the current collectors occurred. The compression in turn results in part in undefined folds, as can be clearly seen, for example, in the region directly above the contact plate 118, where individual turns of the edge are bent in completely different directions. This makes large-area, positive contact between the current collector edge 108 and the contact plate 118 more difficult.

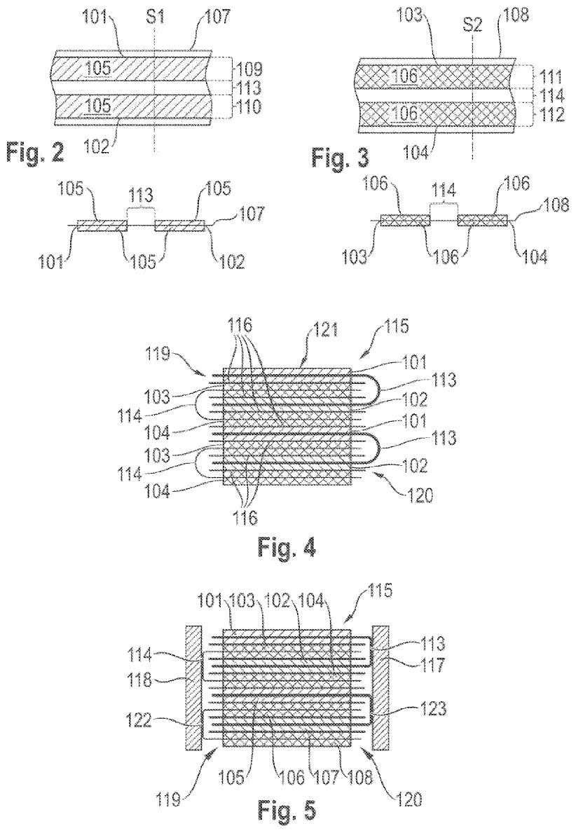

FIG. 2 shows a strip-shaped current collector 107, to which the first strip-shaped anode 101 and the second strip-shaped anode 102 are applied, on the one hand in a plan view from above and on the other hand in a cross-sectional view (section along S1).

The first anode 101 and the second anode 102 each comprise a strip-shaped layer of the electrode material 105 on both sides of the common current collector 107. The strip-shaped current collector 107 comprises a first main region 109 and a second main region 110, of which the first main region 109 is loaded with the strip-shaped layers of the negative electrode material 105 of the first anode 101 and the second main region 110 is loaded with the strip-shaped layers of the negative electrode material 105 of the second anode 102. Between the first main region 109 and the second main region 110, there is a strip-shaped, material-free connecting portion 113 which connects the first main region 109 and the second main region 110 to each other and which is not loaded with the electrode material 105.

FIG. 3 shows a strip-shaped current collector 108, to which the first strip-shaped cathode 103 and the second strip-shaped cathode 104 are applied, on the one hand in a plan view from above and on the other hand in a cross-sectional view (section along S2).

The first cathode 103 and the second cathode 104 each comprise a strip-shaped layer of the electrode material 106 on both sides of the common current collector 108. The strip-shaped current collector 108 comprises a first main region 111 and a second main region 112, of which the first main region 111 is loaded with the strip-shaped layers of the positive electrode material 106 of the first cathode 103 and the second main region 112 is loaded with the strip-shaped layers of the positive electrode material 106 of the second cathode 104. Between the first main region 111 and the second main region 112, there is a strip-shaped, material-free connecting portion 114 which connects the first main region 111 and the second main region 112 to each other and which is not loaded with the electrode material 106.

The assembly 115 shown in FIG. 4 (cross-sectional view) is formed from the anodes 101 and 102 shown in FIG. 2 and the cathodes 103 and 104 shown in FIG. 3. For this purpose, the ribbon-shaped anodes 101 and 102 and the cathodes 103 and 104 are each brought into alignment with one another by bending the common current collector 107 and 108, wherein the cathode 103 is simultaneously arranged between the anodes 101 and 102 and the anode 102 is arranged between the cathodes 103 and 104 and all adjacent electrodes are separated from one another by separator layers 116 arranged between them. The resulting stack of the sequence anode 101/separator layer 116/cathode 103/separator layer 116/anode 102/separator layer 116/cathode 104 can be wound in a spiral around an axis in a further step. The assembly 115 is then in the form of a cylindrical winding with two terminal end faces 119 and 120 and a winding shell 121, in which the electrodes 101, 102, 103 and 104 are spirally wound. The cross-section shown is a section through two adjacent turns of such a spiral winding.

As a result, the cathode 103 is sandwiched in the winding between the anodes 101 and 102 and the anode 102 is sandwiched between the cathodes 103 and 104. Only the material-free, now bent connecting section 114 protrudes from the left side 119 of the assembly 115, and the material-free, now bent connecting section 113 protrudes from the opposite right side 120.

FIG. 5 shows an assembly 115 in the form of a prismatic stack. The electrodes 101, 102, 103 and 104 as well as 105, 106, 107 and 108 are stacked in the stack, each separated by separator layers 116. The electrodes have a rectangular basic shape. The electrodes 101 and 102, 103 and 104, 105 and 107 as well as 106 and 108 each have a common current collector and are connected to each other via the bent, material-free connecting sections 113 and 114 and 122 and 123.

Only the material-free connecting sections 114 and 122 coupled to positive electrodes protrude from the left 119 side of the stack 115, and the material-free connecting sections 113 and 123 coupled to negative electrodes protrude from the right, opposite side 120. The bent connecting sections 114 and 122 are in direct contact with a contact sheet metal member 118. The bent connecting sections 113 and 123 are in direct contact with a contact sheet metal member 117. Since the contact metal members 117 and 118 have been applied to the sides 119 and 120 with slight pressure, there is two-dimensional contact with the four connecting sections 113, 123, 114 and 123. Preferably, the bent connecting sections 113, 123, 114 and 123 are welded to the contact metal members 117 and 118.

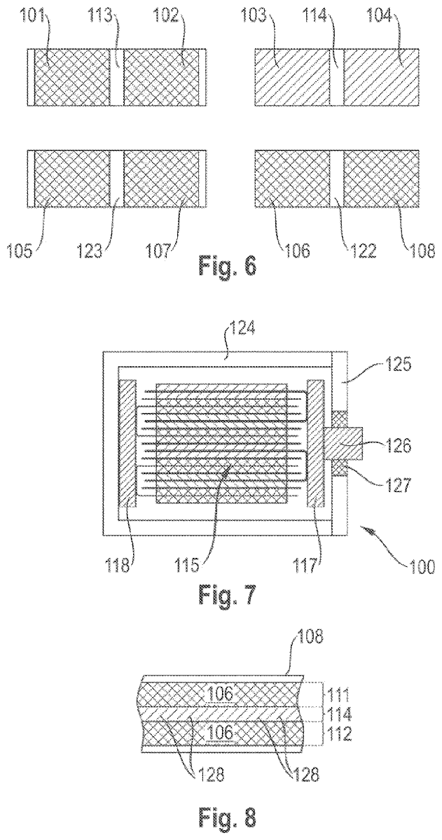

FIG. 6 shows a top view of the electrodes 101, 102, 103 and 104 as well as 105, 106, 107 and 108. The material-free connecting sections 113 and 114 and 122 and 123 are clearly visible. To produce the stack 115, the electrodes connected to each other via the respective connecting section must be brought into alignment with each other by bending the connecting section over. Oppositely polarized electrodes are then sandwiched together with the result shown in FIG. 5.

FIG. 7 shows an energy storage element 100. It comprises the prismatic assembly 115 shown in FIG. 5 and a prismatic housing. The prismatic housing is composed of the cup-shaped housing part 124 and the lid component 125. The contact pole 126, which is connected to the contact sheet metal member 117 by welding, is guided through the lid component 125. The contact pole 126 is electrically insulated from the lid component 125 by means of the insulating element 127. The contact sheet metal member 118 is welded to the bottom of the housing part 124.

In FIG. 8, a current collector is shown with two strip-shaped strips of an electrode material 106 which are connected by a structurally weakened strip-shaped, material-free connecting section 114. A plurality of small cuts 128 are made in the connecting section 114 to structurally weaken it. These facilitate the processing of the electrodes into a spiral winding.

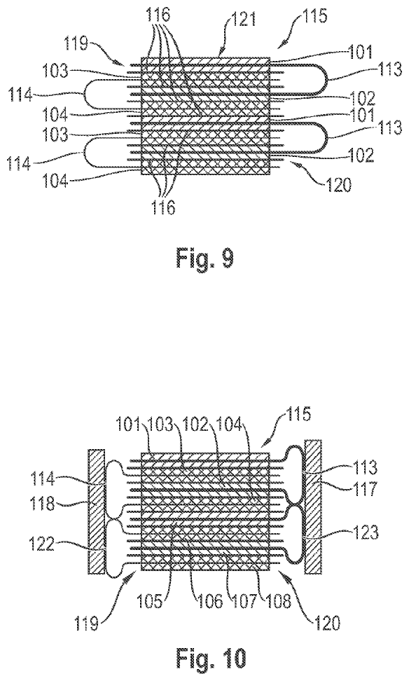

FIG. 9 shows an assembly 115 which differs from the assembly shown in FIG. 4 only in that the connecting sections 113 and 114 of the current collectors are comparatively longer and therefore protrude further from the side of the stack. Such embodiments enable configurations in which connecting sections of adjacent turns are not only connected to each other via a contact sheet metal member but are in direct contact with each other.

FIG. 10 shows an assembly 115 which differs from the assembly shown in FIG. 5 only in that the connecting sections 113 and 123 as well as 114 and 122 of the current collectors are comparatively longer. In the embodiment shown, they are so long that they can be deformed by the contact sheet metal members 117 and 118 so that they are in direct contact with neighboring connecting sections (here the connecting section 114 with the connecting section 122 and the connecting section 113 with the connecting section 123). This creates an ideally almost continuous conductive surface underneath the contact sheet metal members 117 and 118, which considerably favors the dissipation of thermal energy as well as the electrical connection of the assembly 115 to the contact sheet metal members.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: An energy storage element, comprising:
a first anode and a second anode, each of the first anode and the second anode comprising a negative electrode material and a common anode current collector, wherein the common anode current collector comprises a first main region, second main region, and a material-free connecting section that connects the first main region and the second main region, wherein the first main region of the common anode current collector is loaded on both sides with a layer of the negative electrode material to form the first anode, wherein the second main region of the common anode current collector is loaded on both sides with a layer of the negative electrode material to form the second anode, and wherein the material-free connecting section of the common anode current collector is not loaded with the electrode material;
a first cathode and a second cathode, each of the first cathode and the second cathode comprising a positive electrode material and a common cathode current collector, wherein the common cathode current collector comprises a first main region, a second main region, and a material-free connecting section that connects the first main region and the second main region, wherein the first main region of the common cathode current collector is loaded on both sides with a layer of the positive electrode material to form the first cathode, wherein the second main region of the common cathode current collector is loaded on both sides with a layer of the positive electrode material to form the second cathode, and wherein the material-free connecting section of the common cathode current collector is not loaded with the electrode material;
a first contact sheet; and
a second contact sheet,
wherein the first anode, the second anode, the first cathode, and the second cathode form an assembly in which the anodes and cathodes are separated by separator layers in a sequence first anode/separator layer/first cathode/separator layer/second anode/separator layer/second cathode,
wherein, within the assembly, the material-free connecting section of the common anode current collector is bent and connects the first anode and the second anode and the material-free connecting section of the common cathode current collector is bent and connects the first cathode and the second cathode, wherein the bent connecting portion of the anode current collector protrudes from one side of the assembly and the bent connecting portion of the cathode current collector protrudes from another side of the assembly, and
wherein the first contact sheet is in direct contact with the bent connecting section of the common anode current collector and the second contact sheet is in contact with the bent connecting section of the common cathode current collector.

2: The energy storage element according to claim 1, further comprising a cylindrical metal housing comprising a circumferential housing shell and a circular bottom and lid,
wherein the electrodes and the current collectors as well as the layers of electrode materials are ribbon-shaped,
wherein the connecting sections are strip-shaped,
wherein the separator layers are formed from at least one ribbon-shaped separator,
wherein the assembly is in the form of a cylindrical winding with two terminal end faces and a winding shell,
wherein the electrodes and the at least one separator are spirally wound in the cylindrical winding,
wherein the assembly in the form of the cylindrical winding is axially aligned in the metal housing so that the winding shell abuts the inside of the circumferential housing shell, and
wherein the bent connecting sections of the current collectors protrude from the terminal end faces of the winding.

3: The energy storage element according to claim 1, further comprising a prismatic housing,
wherein the electrodes and the current collectors as well as the layers of electrode materials are rectangular in shape,
wherein the connecting sections are strip-shaped,
wherein the separator layers are formed from at least one ribbon-shaped or rectangular separator,
wherein the assembly is in the form of a prismatic stack in which the electrodes and the separator layers are stacked,
wherein the stack is enclosed in the prismatic housing, and
wherein the bent connecting sections of the current collectors protrude from adjacent or opposite sides of the stack.

4: The energy storage element according to claim 1, wherein the first contact sheet metal member is connected to the bent connecting portion of the anode current collector by welding and/or the second contact sheet metal member is connected to the bent connecting portion of the cathode current collector by welding, and
wherein the first contact sheet metal member is mechanically connected to the bent connecting portion of the anode current collector and/or the second contact sheet metal member is mechanically connected to the bent connecting portion of the cathode current collector.

5: The energy storage element according to claim 2, wherein the electrodes have a thickness in a range of 40 μm to 200 μm.

6: The energy storage element according to claim 3, wherein the electrodes have a thickness in a range of 40 μm to 1000 μm.
